(19) United States
(12) Patent Application Publication
(10) Pub. No.: US 2026/0246337 A1
(43) Pub. Date: Aug. 20, 2026

(54) ELECTRIC MACHINE IN-SLOT COOLING MANIFOLD

(71) Applicant: Ford Global Technologies, LLC, Dearborn, MI (US)

(72) Inventors: Alfredo R. Munoz, Ann Arbor, MI (US); Franco Leonardi, Saline, MI (US); Joel Hetrick, Ann Arbor, MI (US); Nicholas B. Chase, Royal Oak, MI (US); Andrew Stankovich, Howell, MI (US)

(21) Appl. No.: 19/046,344

(22) Filed: Feb. 5, 2025

(51) Int. Cl. H02K 9/19; H02K 15/142; H02K 15/40

(52) U.S. Cl. CPC H02K 9/19; H02K 15/142; H02K 15/40

(57) ABSTRACT

An overmolded cooling manifold of a stator of an electric machine is disclosed that may be assembled more efficiently than other cooling systems. The manifold may be formed by overmolding a first side of a first half of the stator and a second side of a second half of the stator, where the first side and the second side face each other at an axial center of the stator. The first half and the second half may then be clamped together using bolts, or locked together using various interlocking axial features formed in each side of the manifold. An interference fit of the various interlocking axial features may advantageously provide mechanical retention of windings of the stator. The overmolded manifold may enable in-slot cooling in a way that cools the hottest part of the electric machine.

### FIELD

The present description relates generally to methods and systems for cooling an electric motor of a vehicle.

### BACKGROUND/SUMMARY

During operation, an electric machine generates electromagnetic losses in the form of heat, which in most cases are located in a stator of the electric machine. Mechanical retention is used within the slots between the stator windings and core to reduce relative motion.

In one example, cooling of the windings may be accomplished by a cooling system for an electric machine having a stator, the cooling system comprising an overmolded polymer cooling manifold positioned at an axial center of the stator and aligned coaxially with a central axis of the stator, the overmolded polymer cooling manifold formed between a first overmolded side of a first half of the stator and a second overmolded side of a second half of the stator, wherein the overmolded polymer cooling manifold is configured to direct a coolant around windings of the stator.

Via the overmolded polymer cooling manifold, a plurality of passages may be incorporated into the stator that allow the coolant to flow between the stator core and windings for hot spot cooling while providing sufficient mechanical retention.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1A is a perspective view of a portion of an exemplary electric machine including an overmolded cooling manifold;

FIG. 1B is an in-plane cross-sectional view of the electric machine;

FIG. 1C is a perspective view of two halves of a stator of the electric machine;

FIG. 1D is a perspective view of an axial passage created by the overmolded cooling manifold;

FIG. 2 is an in-plane cross-sectional perspective view of a portion of the cooling manifold;

FIG. 3 shows a compression limiting eyelet of the cooling manifold;

FIG. 4 shows a cross section of the compression limiting eyelet;

FIG. 5 shows a plurality of interlocking axial features of the cooling manifold;

FIG. 6 shows a mechanical retention of windings of the stator by the interlocking axial features;

FIG. 7 is a perspective view of an exemplary stamped outer ring used to seal the cooling manifold;

FIG. 8 shows an inner seal and an outer seal of the cooling manifold;

FIG. 9 is a first perspective view of compressible elastomer inserts used in conjunction with the cooling manifold;

FIG. 10 is a second perspective view of the compressible elastomer inserts;

FIG. 11A is a third perspective view of the compressible elastomer inserts;

FIG. 11B is a perspective view of a draft angle pocket in the cooling manifold for the compressible elastomer inserts;

FIG. 11C is a cross section of a slot showing the compressible elastomer inserts;

FIG. 12 is a first perspective view showing a second set of interlocking axial features that provide mechanical retention of windings of the stator;

FIG. 13 is a second perspective view showing a second set of interlocking axial features that provide mechanical retention of windings of the stator;

FIG. 14 is a third perspective view showing a second set of interlocking axial features that provide mechanical retention of windings of the stator;

FIG. 15 shows an exemplary overmolded end ring of the stator;

FIG. 16 shows end windings extending from the overmolded end ring;

FIG. 17 schematically shows an example vehicle powertrain that may comprise an electric machine, in accordance with the present disclosure; and

FIG. 18 is a flowchart illustrating an exemplary method for assembling an electric machine.

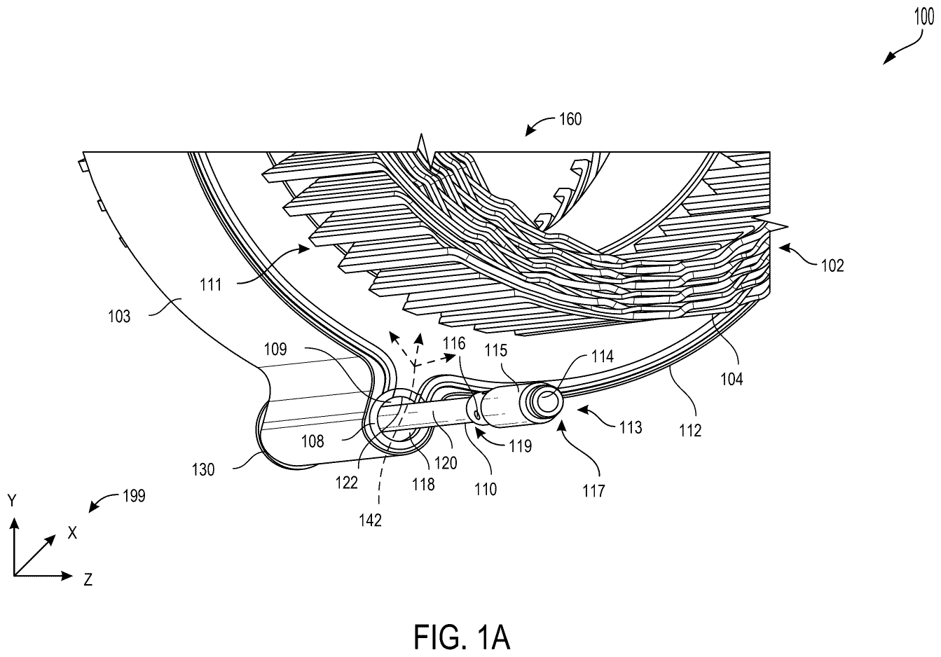

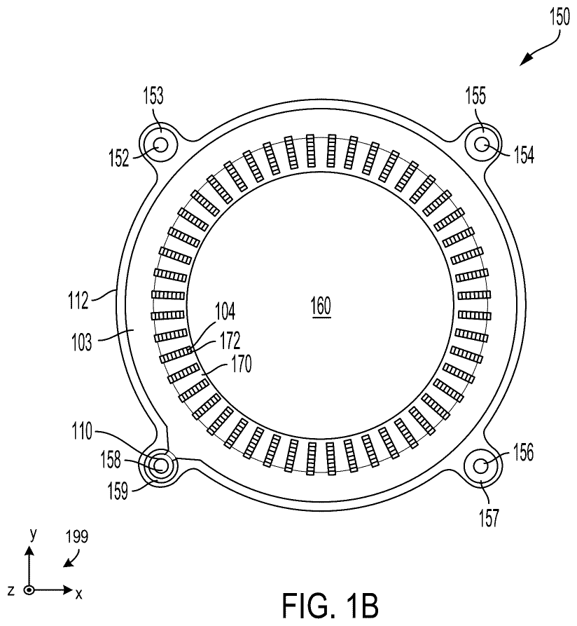

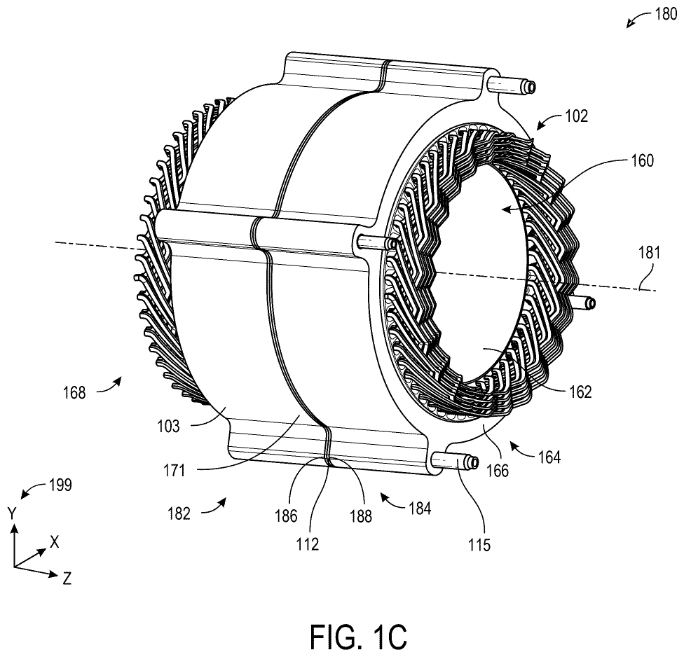

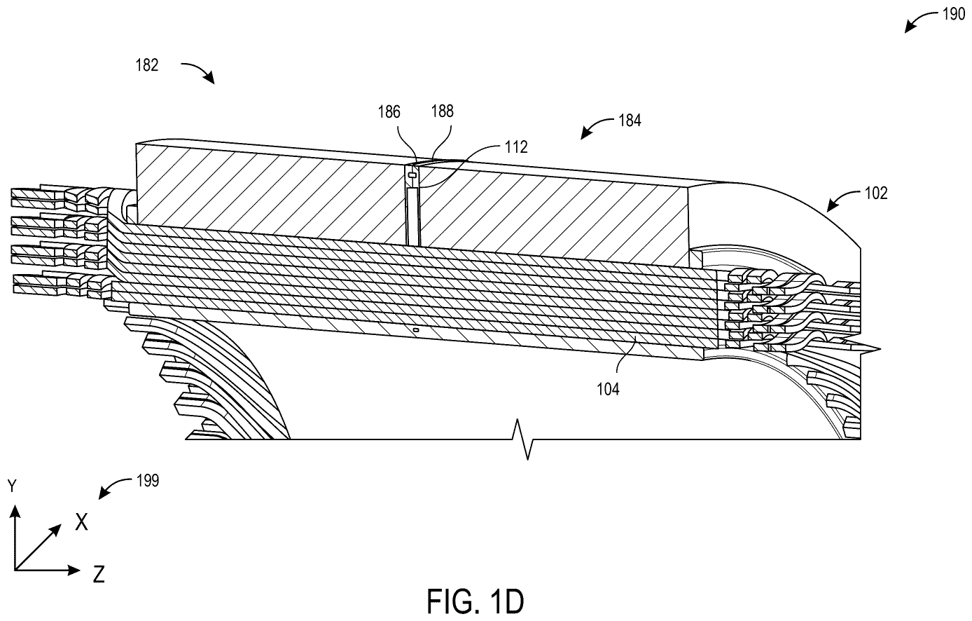

FIGS. 1-16 are shown to scale, although other relative dimensions may be used, if desired.

### DETAILED DESCRIPTION

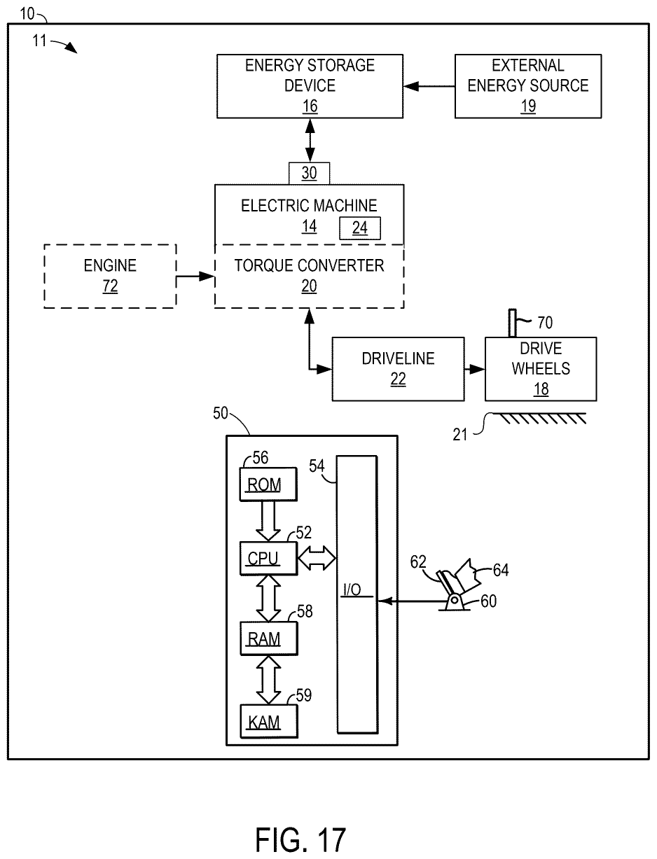

Systems and methods are described herein for cooling an electric machine of a vehicle, specifically by cooling windings at the center of a stator of the electric machine, the hottest part of the electric machine, which may not directly receive coolant supplied by existing cooling solutions. An electric machine with the cooling system of the present disclosure may be incorporated into an exemplary vehicle shown schematically in FIG. 17. FIG. 17 is described first, to provide an overview of an example vehicle system including the electric machine. The cooling of the electric machine is then described in relation to FIGS. 1-16.

Turning first to FIG. 17, an example of a vehicle 10 with a propulsion system 11 (e.g., electric propulsion system) is shown. Propulsion system 11 includes an electric machine 14 (e.g., energy conversion device). The electric machine 14 may be incorporated into an axle of the vehicle 10 and may comprise an in-slot cooling system 24 according to the present disclosure. The electric machine 14 is controlled via controller 50. In some examples, the vehicle propulsion system 11 may further include an engine 72, where the engine 72 may be an internal combustion engine.

The electric machine 14 is further shown coupled to an energy storage device 16, which may include a battery (e.g., traction battery), a capacitor, inductor, or other electric energy storage device. The electric machine 14 can be operated to convert mechanical energy received from the vehicle driveline into a form of energy suitable for storage by the energy storage device (e.g., provide a generator operation). The electric machine 14 can also be operated to supply an output (power, work, torque, speed, etc.,) to drive wheels 18 (e.g., provide a motor operation). It should be appreciated that the electric machine 14 may, in some examples, function only as a motor, only as a generator, or both a motor and generator, among various other components used for providing the appropriate conversion of energy between the energy storage device and the vehicle drive wheels. For instance, the electric machine 14 may include a motor, a generator, integrated starter generator, starter alternator, among others and combinations thereof. The electric machine 14 may also include or be coupled to an inverter 30. The inverter 30 may be configured to condition electrical energy in and out of the energy storage device (e.g., high voltage battery). However, in other examples, the vehicle may not include an inverter.

The energy storage device 16 may be selectively coupled to an external energy source 19. For example, the energy storage device 16 device may be periodically coupled to a charging station (e.g., commercial or residential charging station), portable energy storage device, etc., to allow the energy storage device 16 to be recharged.

While some examples may be described with regard to an electric vehicle without a fuel-based prime mover, such as a plug-in electric vehicle, other examples are also possible. In examples where the electric machine is a hybrid vehicle, the electric machine 14 may be coupled to a torque converter 20. The torque converter 20 is a fluid coupling designed to transfer rotational input from the electric machine 14 to a driveline 22 from a fuel-based prime mover, such as an internal combustion engine. In the hybrid examples, the driveline 22 includes a transmission with gearing and other suitable mechanical components (e.g., a gearbox, axles, transfer cases, etc.) designed to transfer rotational motion to the drive wheels 18. The drive wheels 18 may be supported by and drive vehicle 10 across a surface 21. The torque converter 20 and the electric machine 14 are depicted as an interconnected unit. However, in other examples, the torque converter 20 and the electric machine 14 may include discrete enclosures.

The electric machine 14 may include one or more clutches designed to selectively rotationally couple the rotor of the electric machine 14 to the torque converter 20. For instance, the clutch or clutches may each include plates, splines, and/or other suitable mechanical components allowing the machine to be rotationally connected as well as disconnected from the engine 72 or the torque converter 20.

The depicted connections between electric machine 14, driveline 22, and drive wheel 18 indicate transmission of mechanical energy from one component to another, whereas the connections between the electric machine 14 and the energy storage device 16 may indicate transmission of a variety of energy forms such as electrical, mechanical, etc. For example, torque may be transmitted from the electric machine 14 to drive the vehicle drive wheels 18 via the driveline 22. As described above, the electric machine 14 may be configured to operate in a generator mode and/or a motor mode. In a generator mode, propulsion system 11 receives some or all of the output from electric machine 14, which reduces the amount of drive output delivered to the drive wheel 18, or the amount of braking torque to the drive wheel 18. Operations of the vehicle 10 that use the generator mode may be employed, for example, to achieve energy efficiency gains through regenerative braking, increased engine efficiency (if included), etc. Further, the output received by the electric machine 14 may be used to charge the energy storage device 16. In motor mode, the electric machine 14 may supply mechanical output to the driveline 22, for example by using electrical energy stored in an electric battery. Additionally, the engine 72 may supply rotational output to the driveline 22, in some instances.

The electric machine 14 may also be used to deliver electrical energy to external, auxiliary devices during power take-off. The electric machine 14 may run during power take-off when the drive wheels 18 are not in motion, allowing power output from the electric machine 14 to be directed at least partially towards operating the auxiliary devices.

In examples where the vehicle 10 comprises engine 72, engine 72 may have an output coupled to the torque converter 20 and may be incorporated into the axle of the vehicle. The engine 72 may be controlled via a controller 50. Both the engine 72 and electric machine 14 may act as movers to drive the vehicle 10. For example, the vehicle 10 may be a hybrid vehicle. In examples including engine 72, rotational energy in the form of torque from the engine 72 or other rotational and mechanical energy from components may be converted into electrical energy by the electric machine 14. The output of the electric machine 14 to the torque converter 20 may act as an input for the transfer and transformation of torque into electrical energy during hybrid operations.

The controller 50 receives signals from various sensors of FIG. 17 and employs the various actuators of FIG. 17 to adjust vehicle operation based on the received signals and instructions stored in non-transitory memory of the controller 50. Specifically, controller 50 is shown in FIG. 17 as a conventional microcomputer including: microprocessor unit 52, input/output ports 54, read-only memory 56, random access memory 58, keep alive memory 59, and a conventional data bus. Controller 50 is configured to receive various signals from sensors coupled to the propulsion system 11 and send command signals to actuators of components of the vehicle 10, such as the electric machine 14. Additionally, the controller 50 is also configured to receive pedal position (PP) of a pedal 62 actuated by a user 64. The PP may be estimated by and received from a pedal position sensor 60 coupled to the pedal 62. Therefore, in one example, the controller 50 may receive a pedal position signal and adjust actuators in the electric machine 14 based the pedal position signal to vary the rotational output of the electric machine 14. The sensors communicating with the controller 50 may include an electric machine sensor (e.g., resolver or Hall effect sensor for sensing a rotor position of the electric machine), and wheel speed sensor 70, accelerometer, etc. The controller 50 may send commands to a pump (not shown) to control pressure and flow rate of coolant fluid flowing through the in-slot cooling system 24 of the electric machine 14.

The electric machine 14 may comprise a rotor and a stator, wherein the stator circumferentially surrounds the rotor with a gap maintained therebetween. Conductors (e.g., windings, copper wires) adapted to generate a magnetic field in order to rotate the rotor may extend through the stator. The conductors may be susceptible to excessive heat due at least in part to high electrical power. Thus, the in-slot cooling system 24 may be employed to reduce a temperature of the conductors. For example, the in-slot cooling system 24 in accordance with the present disclosure may include coolant fluid flowing within slots (e.g., through holes) in the stator wherein the conductors are positioned. Thus, coolant fluid may surround a full length of the conductors, thereby increasing cooling effects of the coolant fluid compared to systems wherein coolant contacts only the ends of the conductors not within the stator. In particular, the in-slot cooling system 24 may channel the coolant fluid (also referred to herein as coolant) to portions of the stator via an overmolded polymer manifold positioned at an axial center of the stator, as described in greater detail below.

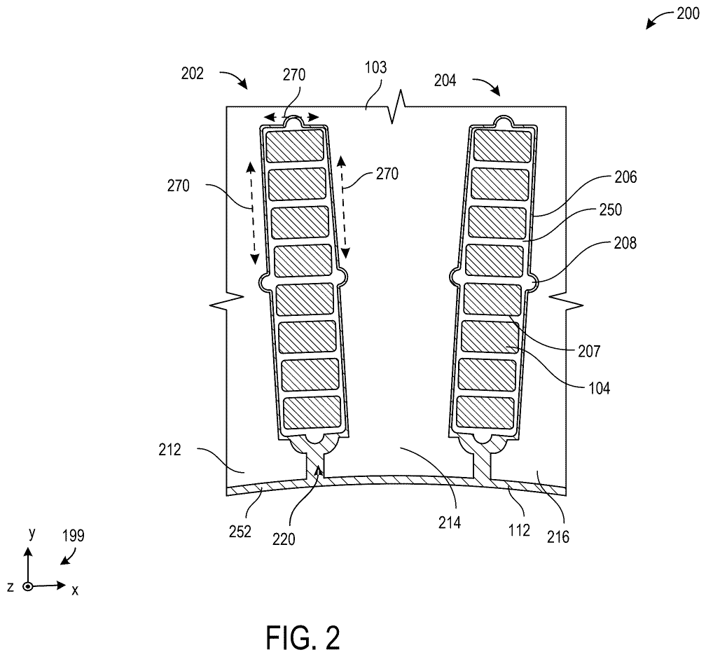

Referring now to FIG. 1A, a first perspective view of a portion of an electric machine 100 is shown, including a stator 102. Stator 102 comprises a plurality of windings 104, through which a current is introduced to generate a magnetic field used to rotate a rotor (not depicted in FIG. 1) positioned in an air gap 160 within stator 102. Stator 102 may include a stator core 103, where a first half of stator core 103 is shown in FIG. 1A. A second half of stator core 103 is not shown to expose the windings 104. A set of reference axes 199 is shown depicting an alignment of electric machine 100, which is also shown in FIGS. 2-16.

During operation of electric machine 100, heat may accumulate in electric machine 100, where the heat may be greatest at the windings 104, which may be referred to herein as a winding hot spot. To cool the winding hot spot, a coolant, such as oil, automatic transmission fluid, dielectric fluids, etc., may be flowed to the windings 104 via an overmolded polymer cooling manifold 112 positioned at an axial center of stator 102. Overmolded polymer cooling manifold 112 may be made by overmolding two halves of stator 102 and creating part of the manifold on each half of stator 102. FIG. 1A depicts a first half of manifold 112 formed by overmolding the first half of stator core 103. A second half of manifold 112 may be formed by overmolding the (transparent) second half of stator core 103. The polymer used may be a thermoset polymer to allow for thin walls for high efficiency applications, or a thicker-walled thermoplastic polymer for applications that can sacrifice efficiency to reduce resources. Depending on the polymer used, the overmolding may be manufactured using transfer molding, injection molding, injection compression molding, etc.

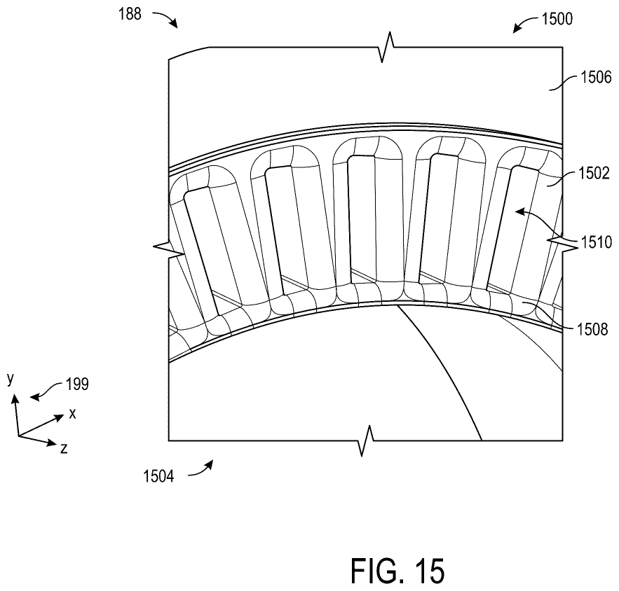

Referring briefly to FIG. 1C, a perspective view 180 of stator 102 is shown, where stator 102 includes a first half stator 182 and a second half stator 184. First half stator 182 and second half stator 184 are coaxially aligned around a central axis 181. Overmolded polymer cooling manifold 112 is arranged between and formed by overmolding both of first half stator 182 and second half stator 184, at an axial middle of stator 102. Thus, overmolded polymer cooling manifold 112 has a first side 186, and a second side 188, where the coolant is channeled between first side 186 and second side 188. Overmolded polymer cooling manifold 112 extends circumferentially around stator 102 from an outer perimeter 171 of stator 102 to air gap 160 inside stator 102, as shown in FIG. 1D. An inner circumferential surface 162 of air gap 160 may also be overmolded, such that the overmolded material extends from overmolded polymer cooling manifold 112 at the axial center of stator 102 to a first outer side 164 of second half 184. The overmolded material may also extend across an outer surface 166 of stator core 103 at first outer side 164, around end windings extending out of stator 102, as described in more detail below in reference to FIG. 15. The overmolded material may also extend from overmolded polymer cooling manifold 112 at the axial center of stator 102 to a second outer side 168 of first half 182 of stator 102, and across an outer surface of stator core 103 at second outer side 168, around end windings extending out of first half 182 of stator 102 in a similar fashion.

FIG. 1D shows a cutaway view 190 of perspective view 180, where a cross section of overmolded polymer cooling manifold 112 is shown as a circumferential passage created by first side 186 and second side 188. Overmolded polymer cooling manifold 112 routes the coolant to a center of the plurality of windings 104, as described in greater detail below.

Returning to FIG. 1A, cooling manifold 112 distributes the coolant circumferentially to each of a plurality of stator slots 111. The coolant also flows axially down the slots to cool the stack windings. At the end of the stator core, the coolant exits stator 103 and flows onto the end windings 104 providing additional end winding cooling. Rotor spray cooling may be used to provide additional end winding cooling.

In some examples, stator core 103 may be secured to a housing of electric machine 100 via a plurality of bolts, which pass through a respective plurality of bolt hole eyelets 108 of respective bolt holes 109 of manifold 112, to provide a rigid clamping path between the heads of bolts and a housing of the electric motor, and allow the main body of manifold 112 to be made of inexpensive and easily manufactured materials, such as injection molded plastic. In some examples, the plurality of bolts may include a hollow bolt 110, which may be positioned at one side of stator 102 and aligned parallel with a central axis of stator 102. Hollow bolt 110 may be similar to bolts typically used to clamp stator 102 to the housing. However, bolt 110 may serve a dual purpose of both clamping stator 102 and providing a coolant passage 113 to a plurality of axial positions of stator core 103. It should be appreciated that in other examples, one or more, or all of the bolts may be hollow bolts such as hollow bolt 110, and the coolant may be delivered to windings 104 of stator 102 via all of the hollow bolts in a similar manner.

The coolant may be fed to stator 102 via coolant passage 113. Hollow bolt 110 may thread into the housing at a first portion 117 of hollow threaded bolt section 115. A second portion 119 of hollow threaded bolt section 115 may extend into stator core 103. Second portion 119 may include one or more radial holes 116 positioned around a circumference of sides of hollow threaded bolt section 115, which may allow the coolant to flow from coolant passage 113 to a passage 118 between a stator core ear hole and an outer circumference 120 of hollow bolt 110 that is sealed to a head 130 of bolt 110 and the housing by a clamping force of bolt 110. The coolant may flow through an aperture 114 to the first portion 117 of hollow threaded bolt section 115 and into the second portion 119. Coolant may exit hollow threaded bolt section 115 into passage 118 via the one or more radial holes 116 to in-slot cooling manifold 112 via an aperture 122 in cooling manifold 112. Manifold 112 may distribute the coolant circumferentially around stator 102 and radially inward towards a center of stator 102, in a direction generally indicated by a plurality of arrows 142. As described in greater detail below, the coolant may circulate around and cool windings 104 from the center of stator 102 to axial ends of stator 102, unlike other alternative cooling solutions that rely on circulating a coolant around an outer surface of stator core 103, solutions that rely on only cooling end windings 104, or solutions that direct the coolant to an interior of stator 102 from the axial ends.

FIG. 1B is an in-plane cross-sectional view 150 of cooling manifold 112, showing a first bolt hole 152 with a respective bolt hole eyelet 153; a second bolt hole 154 with a respective bolt hole eyelet 155; a third bolt hole 156 with a respective bolt hole eyelet 157; and a fourth bolt hole 158 with a respective bolt hole eyelet 159. One or more of eyelets 153, 155, 157, and 159 may be compression limiting eyelets such as bolt hole eyelet 108 of FIG. 1A. While four bolt holes/eyelets are depicted in FIG. 1B, it should be appreciated that in other examples, a greater or lesser number of stator bolts may be used. FIG. 1B shows a plurality of windings 104 extending towards the viewer, through a plurality of winding slots 172 in stator core 103. Winding slots 172 extend radially outward from air gap 160 towards an outer circumference of electric machine 100 between similarly aligned portions 170 of stator core 103, referred to herein as ribs.

Referring now to FIG. 2, an in-plane cross-sectional perspective view 200 is shown of a portion of manifold 112 including a first winding slot 202 and a second winding slot 204 of the windings 104 of FIG. 1A. Each of winding slots 202 and 204 may be formed between teeth of stator core 103. For example, first winding slot 202 is formed between a first tooth 212 and a second tooth 214, and second winding slot 204 is formed between second tooth 214 and a third tooth 216. Ribs 170 of manifold 112 described in reference to FIG. 1B may be aligned with the teeth of stator core 103.

Ribs 170 may be configured to provide a series of interconnected passages 250 that extend around an edge of each winding slot 172 (e.g., winding slots 202 and 204), to allow coolant to circulate around windings 104 both axially and radially. The coolant may also be routed in between and along the windings 104 where passages 250 extend in an axial direction, along the z axis indicated in reference axes 199. In this way, the coolant may be directed efficiently around the windings 104 of winding slots 202 and 204. By directing the coolant along the passages 250 radially and axially around and along each of winding slots 202 and 204, and circumferentially around stator 102 via the passages 207, an amount of heat transferred from the windings 104 of winding slots 202 and 204 to the coolant may be increased in comparison to other cooling solutions that direct the coolant at other surfaces of stator 102.

Winding slots 202 and 204 may be overmolded to prevent leakage of fluid through small gaps between laminations of stator core 103 or out of the tooth tip openings 220. If there is contact and relative motion between wire polymer coating (e.g. enamel, polyether-ether-ketone (PEEK), etc.) of the windings 104 and stator core 103, overmolded lining 206 may prevent the wire polymer coating from being degraded by edges of the stator core laminations. As described above, passage 250 may be left between the windings 104 and the overmolded lining 206 to allow for axial and/or radial fluid flow. A direction of flow of the coolant through the passages 250 is primarily in the z dimension as indicated by axis system 199. Coolant may also flow in the direction indicated by a set of arrows 270. The flow may be directed either up or down the passage 250. In some examples, the passages 250 may include additional features such as axial grooves 208 to increase an efficiency of coolant flow.

Overmolded lining 206 may extend into the tooth tip openings 220 and into an inner diameter of overmolded polymer cooling manifold 112 creating an air gap sleeve 252. The center manifold, liner, air gap sleeve and end ring are combined into one overmolded part (per stator half), reducing resource requirements and creating a continuous passage that does not rely on additional sealed interfaces that would be included if they were separate parts. By overmolding half the stator at a time, a manufacturability of the overmold process may be increased, as it can be difficult to overmold long stator cores. It also enables an axial center-to-end flow of coolant, which increases the efficiency of the coolant flow relative to axial end-to-end flow without a center manifold.

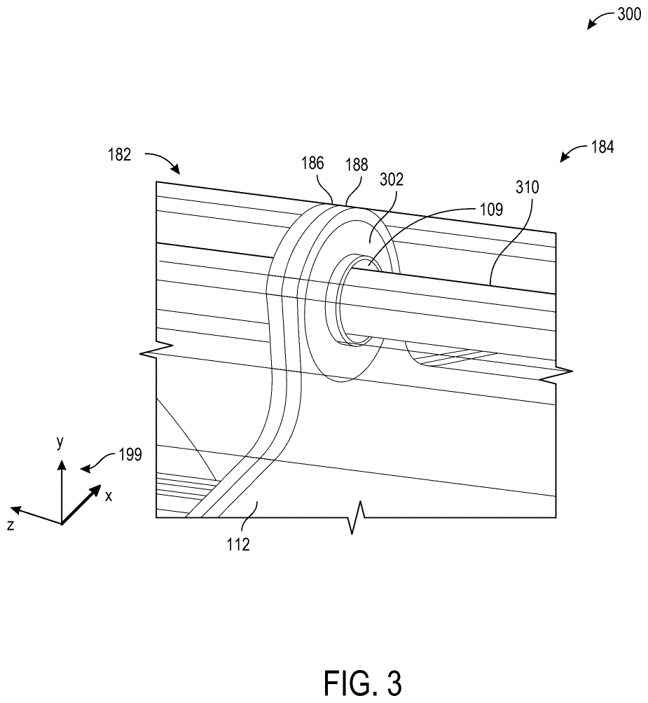

Referring to FIG. 3, an expanded perspective view 300 of overmolded polymer cooling manifold 112 shows one overmolded compression limiting eyelet of a plurality of overmolded compression limiting eyelets 302, through which a bolt 310 (e.g., hollow bolt 110) passes. First half stator 182 and second half stator 184 are aligned during assembly to ensure that in-slot cooling channels, air gap, bolt holes 109, and other features are aligned. This may be accomplished via various interlocking features.

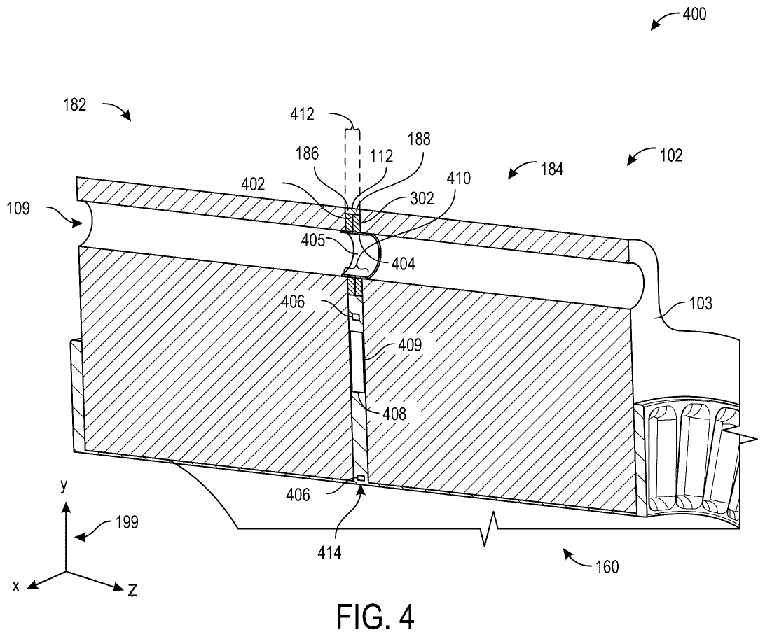

FIG. 4 shows a perspective view 400 of overmolded polymer cooling manifold 112 with a cross-sectional, cutaway view of compression limiting eyelet 302. Compression limiting eyelet 302 may comprise a first overmolded portion 402 and a second overmolded portion 404, where second overmolded portion 404 includes a cylindrical wall 405 configured to snugly fit around an inner circumference of a respective bolt hole 109. Cylindrical wall 405 may have a length 410 in a z dimension (in accordance with reference axes 199) that is greater than a width 412 of overmolded polymer cooling manifold 112, and may be centered axially at a middle point 414 of overmolded polymer cooling manifold 112, such that first overmolded portion 402 may be positioned around cylindrical wall 405 and engaged with second overmolded portion 404 via a small clearance or interference fit.

In some examples, cylindrical wall 405 may be replaced by a dowel that is inserted into both of first overmolded portion 402 of compression limiting eyelet 302 of first half stator 182 and a second overmolded portion of compression limiting eyelet 302 of second half stator 184. The dowel may be used to align first half stator 182 and second half stator 184. Second half stator 184 may then be rotated around the dowel until second half stator 184 engages with a compression limiting eyelet 302 on another side of stator 102. Once first half stator 182 and second half stator 184 are rotated into alignment using the dowel, the dowel may be removed, and first half stator 182 and second half stator 184 may be axially clamped and held into position using bolts (e.g., hollow bolt 110).

Overmolded polymer cooling manifold 112 may be sealed via one or more seals 406, such that when sealed, overmolded polymer cooling manifold 112 is formed between first side 186 (an overmolded portion of first half stator 182) and second side 188 (an overmolded portion of second half stator 184), and coolant introduced into overmolded polymer cooling manifold 112, for example, via hollow bolt 110, is prevented from flowing into bolt hole 109 and/or into air gap 160. Seals 406 are described in greater detail below.

When first half stator 182 and second half stator 184 are sealed to form overmolded polymer cooling manifold 112, one or more recessed portions 408 at an inner (e.g., axially central) edge of either or both of first half stator 182 and second half stator 184 may form one or more passages 409. The one or more passages 409 may direct a flow of the coolant through overmolded polymer cooling manifold 112 circumferentially around stator 102 to cool windings 104 at different locations of stator 102.

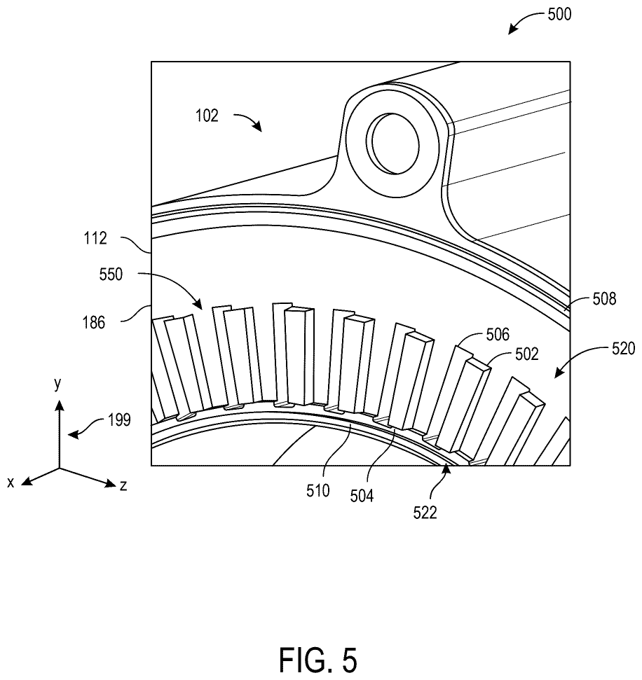

In an alternative embodiment, first half stator 182 and second half stator 184 may not be aligned using cylindrical wall 405 or the dowel, and instead, interlocking axial features of overmolded polymer cooling manifold 112 may be used to engage first half stator 182 and second half stator 184. An example of the interlocking axial features is shown in FIG. 5.

Referring now to FIG. 5, a perspective view 500 of first side 186 of overmolded polymer cooling manifold 112 shows a plurality of interlocking axial features 550 in the polymer overmolded material. Interlocking features 550 may provide alignment of first half stator 182 and second half stator 184 and allow first half stator 182 and second half stator 184 to engage axially with each other. Interlocking axial features 550 may also be used to clamp the windings, to prevent relative motion, by slightly rotating first half stator 182 and second half stator 184 prior to bolt installation. In other embodiments, there may be a plurality of overmolded stator sub-stacks with manifolds that interlock together in a similar manner.

As shown in perspective view 500, interlocking axial features 550 include a first plurality of protruding portions 502 of overmolded polymer cooling manifold 112, and a second plurality of recessed portions 504 of overmolded polymer cooling manifold 112. Protruding portions 502 and recessed portions 504 may be interspaced such that each protruding portion 502 is positioned adjacent to a recessed portion 504, as shown in the depicted embodiment. Each protruding portion 502 may be formed of solid overmolded material. An opposing side (e.g., second side 188) of overmolded polymer cooling manifold 112 may include a similar set of protruding portions 502 and recessed portions 504 in an opposite configuration, such that the protruding portions 502 of second side 188 align with the recessed portions 504 of first side 186, and the recessed portions 504 of second side 188 align with the protruding portions 502 of first side 186. As such, first half stator 182 and second half stator 184 may be engaged by a small clearance or interference fit between respective protruding and recessed portions of first side 186 and second side 188, such as when a pressure is applied at outer sides of first half stator 182 and second half stator 184 to push first half stator 182 and second half stator 184 together axially.

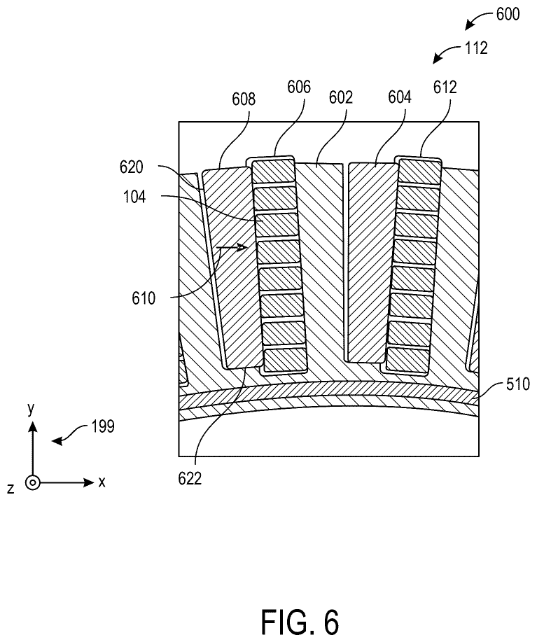

The adjacent recessed portions 504 and protruding portions 502 of each side of overmolded polymer cooling manifold 112 may be positioned with winding slots 506 between them, as shown in greater detail in FIG. 6. In some examples, the interference fit between respective protruding and recessed portions of first side 186 and second side 188 may be at a top side 520 and a bottom side 522 of the respective protruding and recessed portions, rather than along the shared surface extending radially and vertically in FIG. 5. The two sides of stator 102 may then be rotated slightly to pinch the windings in each winding slot 506 against the pairs of protruding/recessed portions of overmolded polymer cooling manifold 112 to achieve an additional interference fit between the windings and overmolded polymer cooling manifold 112.

Perspective view 500 additionally shows a first, outer seal 508 positioned at an outer circumference of overmolded polymer cooling manifold 112, and a second, inner seal 510, which may seal and trap coolant within overmolded polymer cooling manifold 112. The first, outer seal 508 and the second, inner seal 510 may each be a non-limiting example of the seals 406 of FIG. 4. The coolant may flow within overmolded polymer cooling manifold 112 to the winding slots 506, and may penetrate the winding slots 506 to cool windings 104 within the winding slots 506, for example, via the passages 250, axial grooves 208, and passages 207 of FIG. 2.

FIG. 6 shows a perspective view 600 of the interlocking axial features 550 in the polymer overmolded material that provide alignment of first half stator 182 and second half stator 184 and allow first half stator 182 and second half stator 184 to engage axially with each other. In particular, a protruding portion 602 (e.g., protruding portion 502) of first side 186 of overmolded polymer cooling manifold 112 is shown adjacent to a first protruding portion 604 of second side 188 of overmolded polymer cooling manifold 112, which may be inserted into a recessed portion 504 of first side 186. A second protruding portion 608 of second side 188 is shown positioned at an opposite side of a winding slot 606 from protruding portion 602 of first side 186. That is, first side 186 is positioned in front of second side 188. A radial surface 620 of second protruding portion 608 may be used to circumferentially align the two halves of the stator, while still allowing a slight rotation to clamp wires of the windings. A bottom surface 622 of second protruding portion 608 may be used to radially align two halves with small clearance or interference fit.

In FIG. 6, second side 188 has been rotated counterclockwise with respect to first side 186, such that a position of second protruding portion 608 with respect to winding slot 606 is adjusted in the direction indicated by arrow 610, such that second protruding portion 608 clamps the windings 104 in winding slot 606. Similarly, a position of first protruding portion 604 is adjusted in the direction indicated by arrow 610 such that first protruding portion 604 clamps the windings 104 in a winding slot 612. In this way, an interference fit between protruding portions of both sides of overmolded polymer cooling manifold 112 and the windings of each winding slot of stator 102 is generated that both locks first half stator 182 to second half stator 184 and provides mechanical retention for the windings 104.

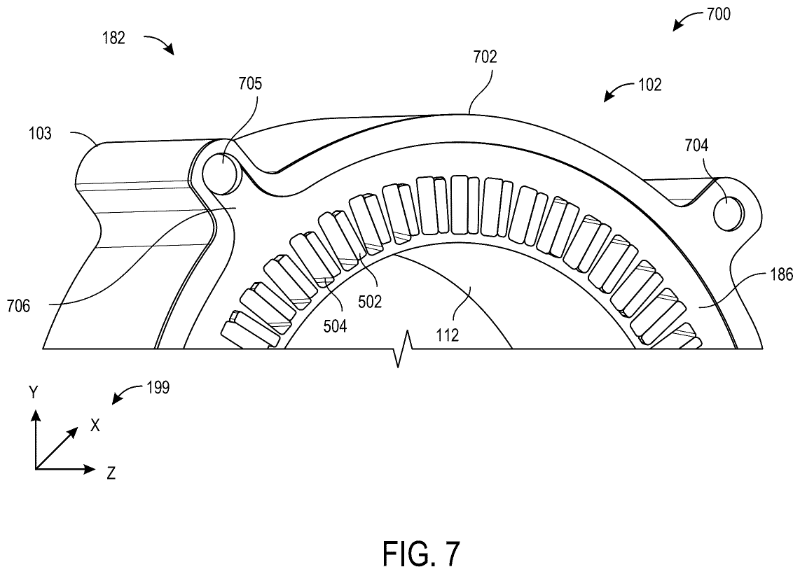

FIG. 7 shows a perspective view 700 of another embodiment of overmolded polymer cooling manifold 112, where a stamped outer ring 702 may be used instead of compression limiters such as compression limiting eyelets 302. Outer ring 702 may be a continuous piece of metal (e.g., steel, aluminum, etc.) that extends around an outer circumference of stator 102 at an edge of overmolded polymer cooling manifold 112 and acting as a limit for the overmolded material. A stamped ring 702 may be included on each stator sub-stack. That is, a first outer ring 702 may be included at an outer circumference of first half stator 182, and first side 186 may be overmolded to an edge of the first stamped outer ring 702 (as depicted in FIG. 7). A second outer ring 702 (not shown in FIG. 7) may be included at an outer circumference of second half stator 184, and second side 188 may be overmolded to an edge of the second stamped outer ring 702. Glue or spreadable sealant (e.g., silicone rubber) may be spread on either or both of an interior surface (e.g., facing first stator half or a respective stator sub-stack) and an exterior surface (e.g., facing second stator half or an opposing stator sub-stack) of stamped ring 702 to seal and bond stamped outer ring 702 to a respective sub-stack or to seal and bond sub-stacks together. Glue or spreadable sealant may also be applied to a continuous surface of overmolded material at an inner circumference of overmolded polymer cooling manifold 112.

Each stamped ring 702 may be configured to encircle each of a plurality of bolt holes 704 (e.g., bolt holes 109). In examples where a hollow bolt is used to introduce the coolant into overmolded polymer cooling manifold 112 as described in reference to FIG. 1A, a portion of stamped ring 702 may be routed around a respective bolt hole 705, such that coolant may flow from the hollow bolt into overmolded polymer cooling manifold 112 via a passage 706.

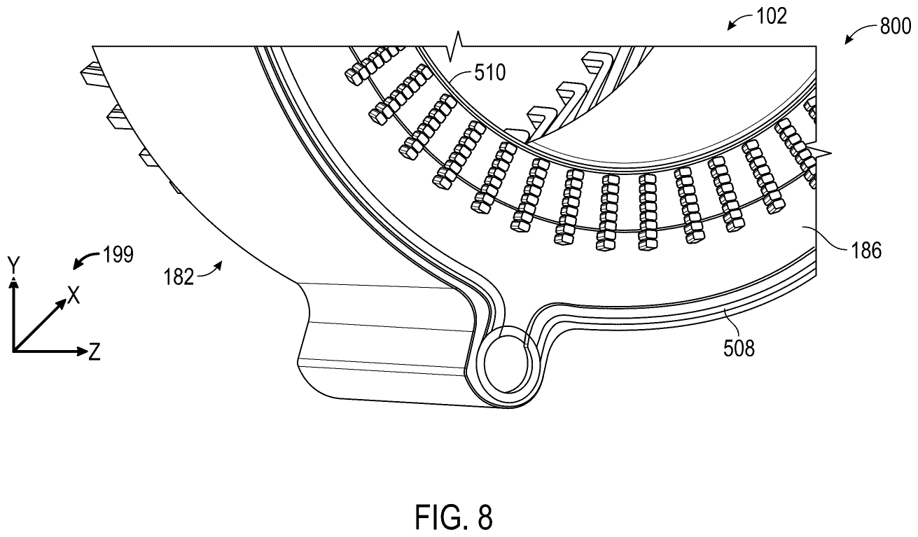

FIG. 8 shows a perspective view 800 of first side 186 of overmolded polymer cooling manifold 112 that shows outer seal 508 and inner seal 510 of FIG. 5. To prevent overmolded polymer cooling manifold 112 from leaking, outer seal 508 may be included near the outer diameter of stator 102 and inner seal 510 may be included near an inner diameter of stator 102. In various examples, outer seal 508 and inner seal 510 may be installed into a molded groove in each of first side 186 and second side 188 of overmolded polymer cooling manifold 112. When stator 102 is compressed axially with bolts, outer seal 508 and inner seal 510 may be compressed into the molded groves sealing interior passages of overmolded polymer cooling manifold 112. In other embodiments, outer seal 508 and/or inner seal 510 may be included with features directly molded into the overmolded material, such as compressible overmolded lips, interlocking groove and rib, etc., or outer seal 508 and/or inner seal 510 may be sealed using a spreadable material such as glue or silicone rubber.

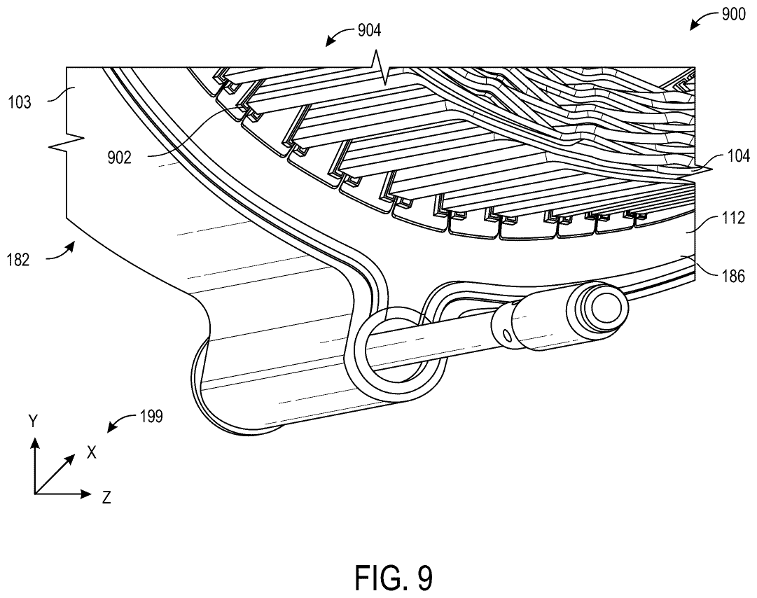

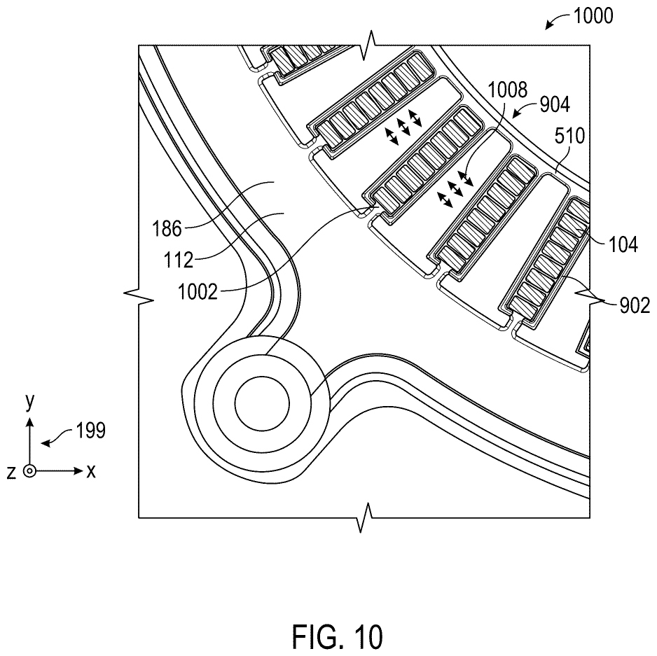

FIG. 9 shows a perspective view 900 of first side 186 of overmolded polymer cooling manifold 112 that shows a plurality of compressible elastomer inserts 902 arranged around the edges of a plurality of winding slots 904 (e.g., windings slots 172). To provide mechanical fixation between the stator core 103 and windings 104 at the center of stator 102, which may be demanded for long stack length electric machines to prevent insulation degradation, compressible elastomer inserts 902 may be included between first side 186 and second side 188 of overmolded polymer cooling manifold 112 at each winding slot 904. The compressible elastomer inserts 902 may provide clearance for wires of windings 104 to be pushed through each winding slot 904 prior to a conventional twist side end winding bend operation. Compressible elastomer inserts 902 are shown in greater detail in FIG. 10.

Referring now to FIG. 10, an expanded view 1000 of a plurality of compressible elastomer inserts 902 is shown. Compressible elastomer inserts 902 may extend around edges of each winding slot 904, except at a radial opening 1002 of each winding slot 904 where coolant may flow into the respective winding slot 904 from overmolded polymer cooling manifold 112. Prior to or during twist side bending of the wires, the stator stack (e.g., first half 182 and/or second half 184) may be compressed, causing outer seal 508, inner seal 510, and compressible elastomer inserts 902 to compress and expand in-plane (in opposing directions indicated by arrows 1008), removing any gaps between the windings 104 and overmolded polymer cooling manifold 112, as well as pushing layers of the windings 104 together. In this way, a mechanical fixation of the windings 104 at the center of stator 102 may be achieved. Compressible elastomer inserts 902 may be formed of a same material as outer seal 508 and inner seal 510, and in some examples, compressible elastomer inserts 902 may be integrated into inner seal 510 to create one single part.

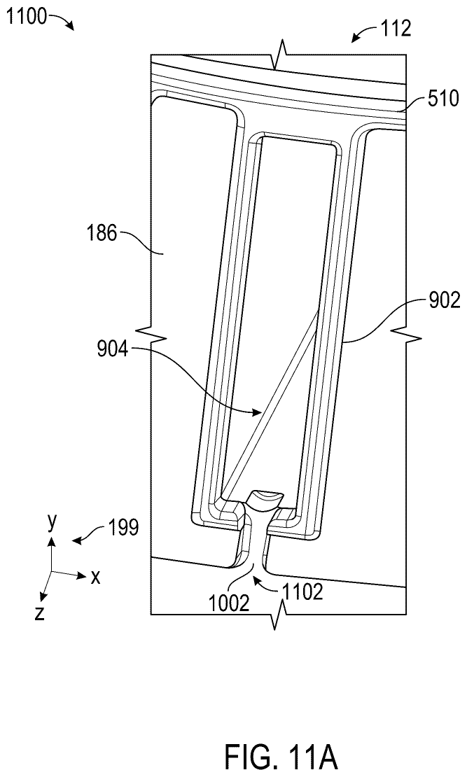

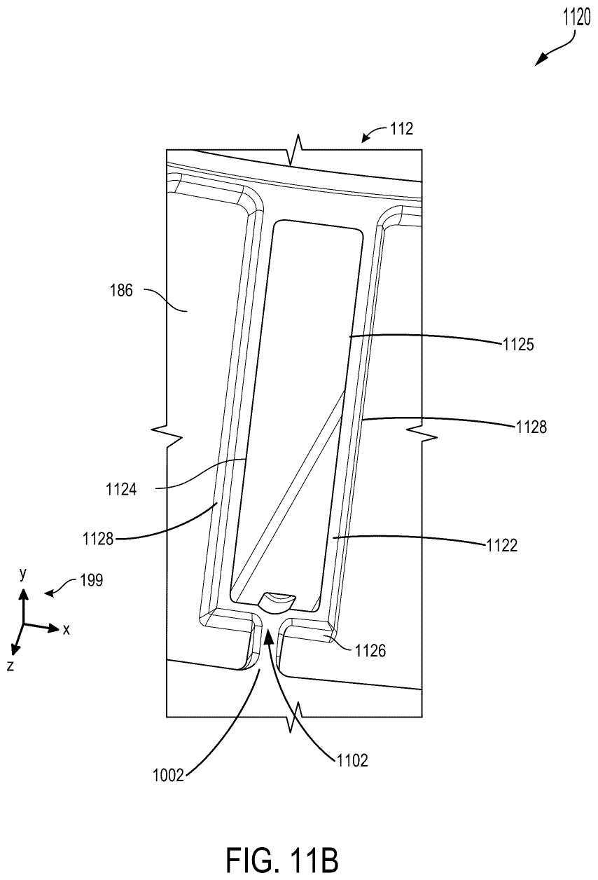

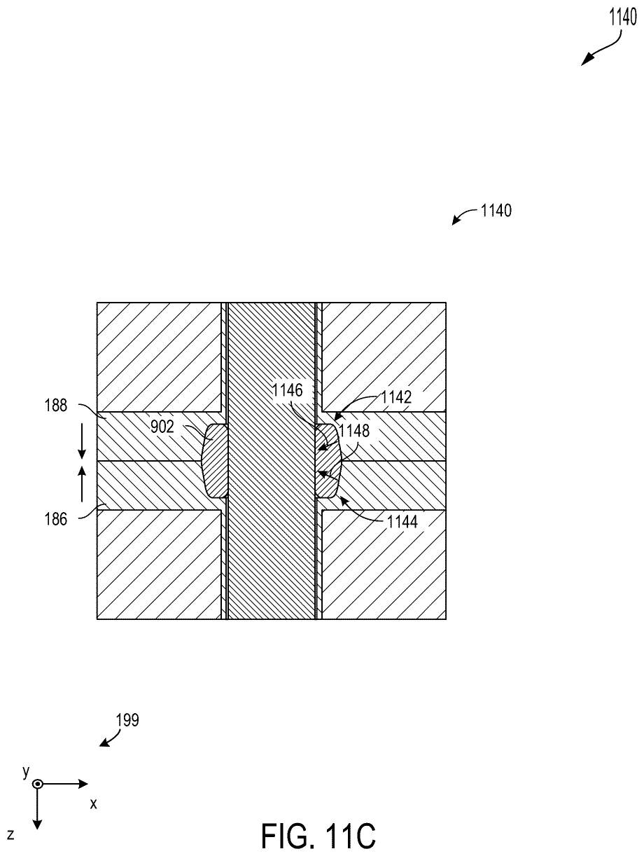

FIG. 11A shows an expanded view 1100 of a compressible elastomer insert 902 inserted into a winding slot 904. The compressible elastomer inserts 902 may be inserted into grooves in overmolded polymer cooling manifold 112 around each winding slot 904. The grooves may include draft angles, which may allow the compressible elastomer inserts 902 to be wedged into the grooves in a manner that increases the interference fit between a respective winding 104, compressible elastomer insert 902, and overmolded polymer cooling manifold 112. The compressible elastomer inserts 902 may not be connected and may leave a space at a portion 1102 of the grooves at radial opening 1002, to allow coolant to flow into a respective winding slot 904.

FIG. 11B shows a perspective view 1120 of a groove 1122 of the overmolded polymer cooling manifold 112 where the compressible elastomer insert 902 may be inserted. The groove 1122 may extend along vertical sides 1124 and 1125 of the winding slot 904. Portion 1102 of the groove 1122 extends inward from vertical sides 1124 and 1125 to radial opening 1002. In particular, perspective view 1120 shows horizontal draft angles 1126 in portion 1102 and vertical draft angles 1128 formed along the vertical sides 1124 and 1125, which may compress the compressible elastomer insert 902 when first side 186 and second side 188 are in face-sharing contact, as shown in FIG. 11C.

FIG. 11C shows a cross-sectional view 1140 of the compressible elastomer insert 902, where the compression of the compressible elastomer insert 902 by draft angles 1128 along vertical sides 1124 and 1125 are indicated by arrows 1146 and 1148. Specifically, a first draft angle 1144 in first side 186 of overmolded polymer cooling manifold 112 exerts a force on compressible elastomer insert 902 inward against a respective winding 104 in a direction indicated by arrow 1148, and a second draft angle 1142 in second side 188 of overmolded polymer cooling manifold 112 exerts a force on compressible elastomer insert 902 inward against the respective winding 104 in a direction indicated by arrow 1146. In this way, a position of the respective winding 104 may be secured upon attachment of first side 186 to second side 188.

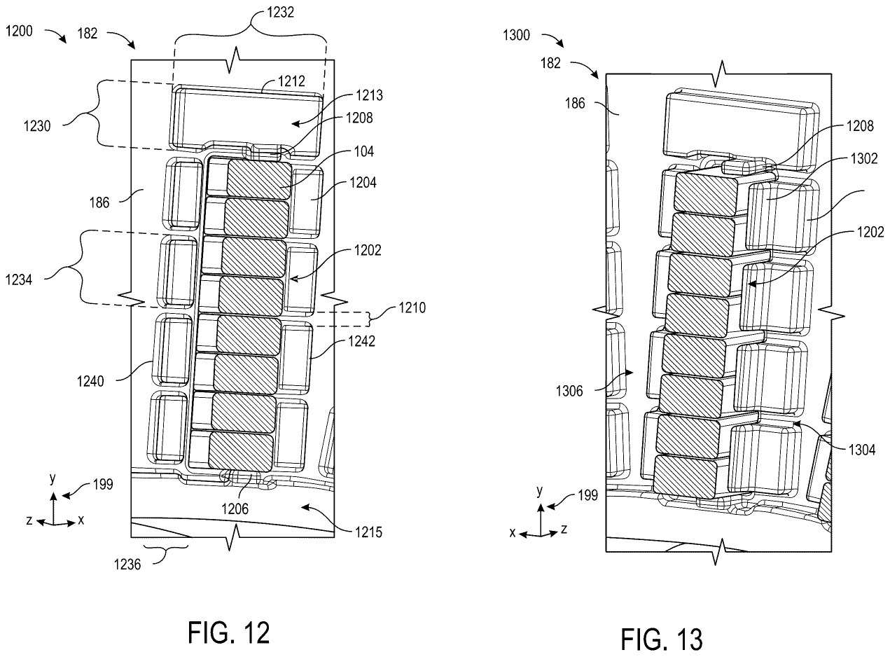

Turning now to FIGS. 12, 13, and 14, in another embodiment, overmolded polymer cooling manifold 112 may additionally or alternatively include a second set of axial interlocking features, where protruding portions of first side 186 and second side 188 of overmolded polymer cooling manifold 112 extend into respective recessed portions of an opposing side of overmolded polymer cooling manifold 112 around the winding slots. The second set of axial interlocking features may serve to align interconnecting sub-stacks (e.g., first half 182 and second half 184). The second set of axial interlocking features may also deform during axial clamping of the sub-stacks, creating an interference fit between the overmolded polymer cooling manifold 112 and the windings providing mechanical retention of the windings 104.

FIG. 12 shows a first perspective view 1200 of a set of windings 104 of a winding slot 1202, where windings 104 are depicted as extending out of first half 182 of stator 102 (in the z dimension indicated by reference axes 199). First side 186 of overmolded polymer cooling manifold 112 covers first half 182, and includes a plurality of raised tabs also extending outward from first half 182, in the z dimension. The raised tabs may be arranged around a perimeter of winding slot 1202. In the depicted embodiment, four side tabs 1204 are positioned at each side of winding slot 1202. Each side tab 1204 may be separated from adjacent side tabs 1204 by an interspacing 1210 to allow coolant to flow into the winding slot 1202. An end tab 1212 is positioned at an outer end 1213 of winding slot 1202 (e.g., in a direction of an outer circumference of stator 102). A first height 1230 and first width 1232 of end tab 1212 may be different from a second height 1234 and second width 1236 of the side tabs 1204. In the depicted embodiment, first height 1230 is equal to second height 1234, and first width 1232 is equal to a distance from a first outer perimeter 1240 of side tabs 1204 on one side of winding slot 1202 to a second outer perimeter 1242 of side tabs 1204 on an opposing side of winding slot 1202. In other embodiments, a greater or fewer number of tabs may be included in overmolded polymer cooling manifold 112, and/or a size of the tabs and interspacing 1210 may be different. Side tabs 1204 and end tab 1212 may have a same height, or a different height.

Each side tab 1204 and end tab 1212 of first side 186 of overmolded polymer cooling manifold 112 may be formed of solid overmold material. Each side tab 1204 and end tab 1212 may be configured to fit into a corresponding recessed portion of second side 188 of overmolded polymer cooling manifold 112 with an interference fit that provides mechanical retention for windings 104. The interference fit may also serve to interlock first half 182 and second half 184 of stator 102.

In various examples, one or more tabs including side tabs 1204 and end tab 1212 may include a portion that extends along windings 104, in face-sharing contact with windings 104. For example, end tab 1212 may include an extended portion 1208 of solid overmold in face-sharing contact with windings 104 positioned at outer end 1213 of winding slot 1202. A second extended portion 1206 of solid overmold may be included in first side 186 of overmolded polymer cooling manifold 112 at inner end 1215 of winding slot 1202, such that pressure exerted on the windings 104 at both of outer end 1213 and inner end 1215 may provide mechanical retention of windings 104. The extended portions 1206 and 1208 may not initially be interlocked, such that there is assembly clearance between the wires and manifold 112. This clearance is necessary for wire insertion force and to prevent scraping the thin wire insulation coating. Once the wires are inserted, the stator sub-stacks may be compressed axially, fully interlocking the extended portions 1206 and 1208 with the other sub-stack's tabs. These features are designed such that as the sub-stacks are clamped axially, the extended portions 1206 and 1208 are compressed between windings 104 and the other sub-stack's tabs, creating an interference fit between the windings 104 and overmolded manifold 112 for winding mechanical retention.

FIG. 13 shows a second perspective view 1300 of the windings 104 of winding slot 1202, where each side tab 1204 includes an extended portion 1302 that extends outward from the side tab 1204 to mechanically retain the windings 104 via the interference fit described above. Similar to extended portions 1208 and 1206, extended portions 1302 may be formed of solid overmold material and may extend into corresponding recessed portions of second side 188 of overmolded polymer cooling manifold 112. For example, extended portions 1302 may be included in first side 186 on a first side 1304 of winding slot 1202, which may engage with recessed portions between tabs 1240 and windings 104 included in second side 188 on the second side 1306.

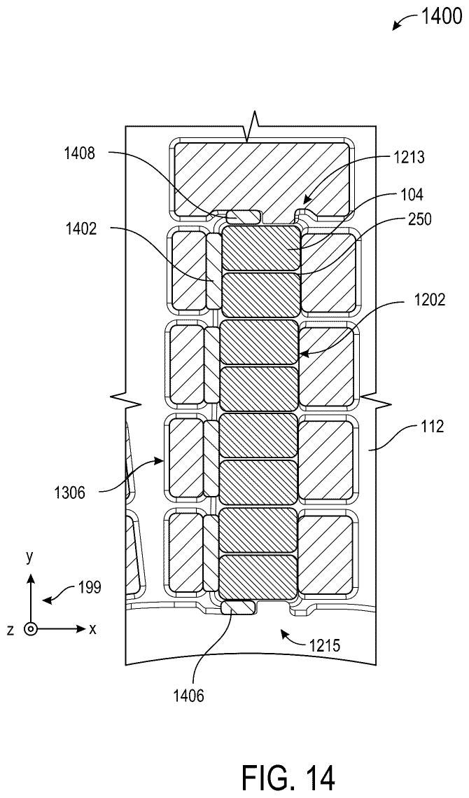

FIG. 14 shows a third perspective view 1400 of the windings 104 of winding slot 1202, which shows a second set of extended portions 1402 protruding from second side 188 to provide mechanical retention of windings 104 at second side 1306 of windings slot 1202 (e.g., in conjunction with extended portions 1302 at first side 1304 of FIG. 13). The second set of extended portions 1402 may be the same as or similar to extended portions 1302 and may share a same shape and dimensions. An extended portion 1408 is also shown at outer end 1213 of winding slot 1202, similar to second extended portion 1308 of FIG. 13, and an extended portion 1406 is shown at inner end 1215 of winding slot 1202, similar to extended portion 1206 of FIG. 12. It should be noted that even with the mechanical retention provided by extended portions 1302, 1206, and 1308 of first side 186 and extended portions 1402, 1406, and 1408 of second side 188, a gap between windings 104 and respective inner-facing sides of the extended portions may still be left to form passages 250 around and between windings 104.

Referring now to FIG. 15, a perspective view 1500 of a portion of second half 184 of stator 102 shows an overmolded end ring 1502 that may be formed around a plurality of winding slots 1510 at outer ends of stator 102. In FIG. 15, end ring 1502 is at an outer end 1504 of second half 184 of stator 102, meaning, opposite overmolded polymer cooling manifold 112 positioned at the axial center of stator 102 (e.g., first outer side 164 of FIG. 1C). In addition to the overmold creating overmolded polymer cooling manifold 112 at the center of the stator to feed coolant into stator 102, the overmold material may also include end ring 1502 for wire bending and retention. End ring 1502 may include curved surfaces 1508 at edges of each winding slot 1510. The curved surfaces 1508 may allow wires of end windings protruding out of winding slots 1510 to be bent around the overmolded end ring 1502 at an outer surface 1506 of second half 184 without using separate tooling. The curved surfaces 1508 may be configured of solid overmold to protect the end windings during the bend operation. This bend operation creates contact between the end windings and stator 102, reducing relative motion during operation of electric machine 100. Overmolded end ring 1502 may also be included at an outer end of first half 186 of stator 102 (e.g., second outer side 168 of FIG. 1C).

For stators designs with more than two overmolded sub-stacks, the center sub-stacks may have halves of overmolded polymer cooling manifold 112 on each end. The end sub-stacks may have overmolded manifolds at the interface to other sub-stacks, and overmolded end ring 1502 on a surface 1506 of stator core 103 adjacent to the end windings. Surface 1506 may be a non-limiting example of surface 166 of FIG. 1C.

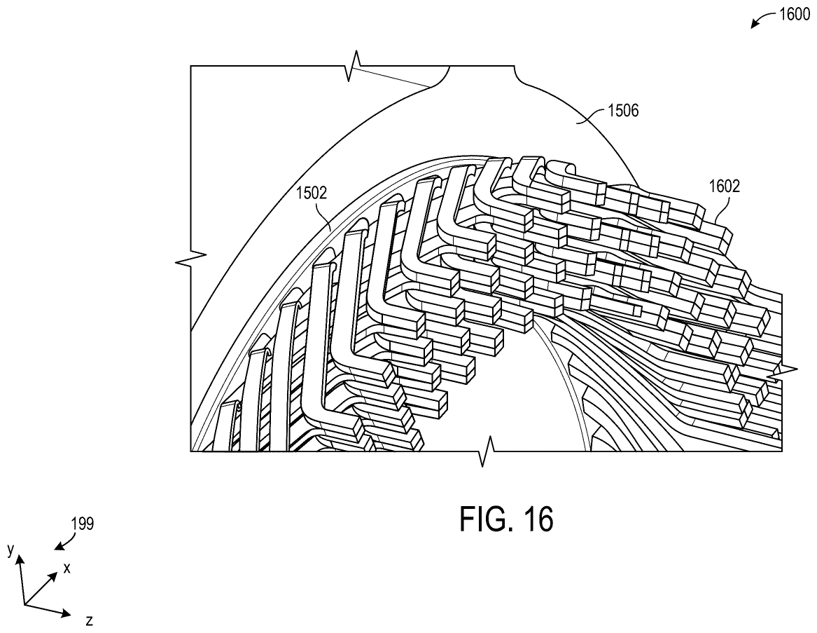

FIG. 16 shows a perspective view 1600 of second half 184 of stator 102, which shows a plurality of end windings 1602 extending out of second half 184. The plurality of end windings 1602 are bent and twisted around end ring 1502, as described above. Without conventional slot liners and varnish, that cannot be used with in-slot cooling, end rings may be relied on to prevent the winding insulation coating (e.g., enamel, PEEK, etc.) from being degraded during use of the electric machine, due to small relative motion between the stator core and the windings, caused by sharp corners of the stator core laminations. Additionally, the end rings may reduce or eliminate the need for tooling that creates the rounded bend in the windings near the stator core end.

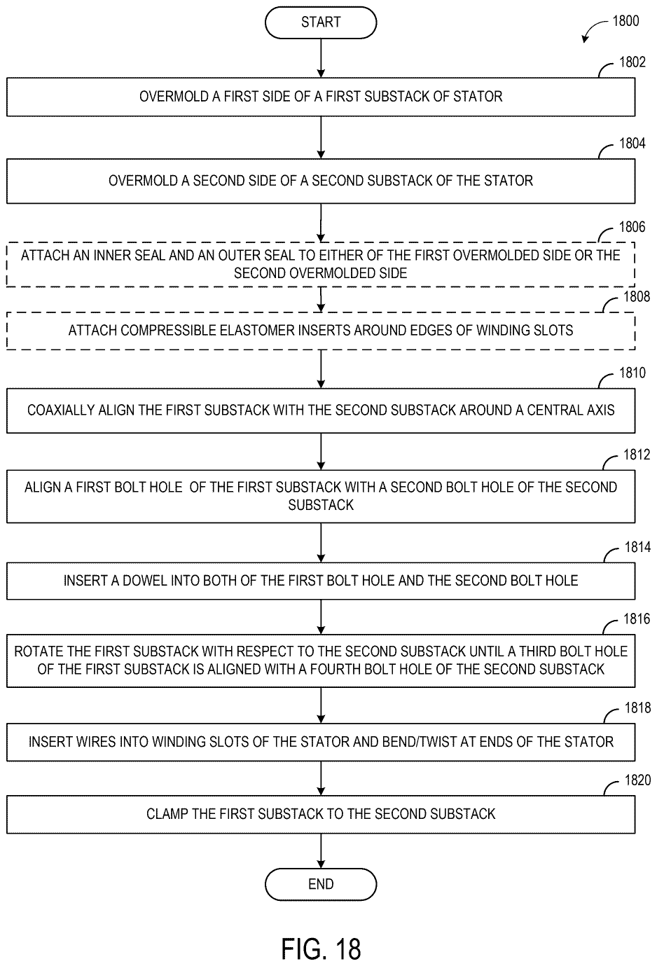

Turning now to FIG. 18, a method 1800 is shown for assembling a stator of an electric machine such as electric machine 100 of FIG. 1. Method 1800 may be performed as part of an automated assembly procedure of a manufacturer of the electric machine. It should be appreciated that method 1800 is an abbreviated method that may not include all the steps involved in assembling the stator.

Method 1800 begins at 1802, where method 1800 includes overmolding a first side of a first substack of a stator of the electric machine with a polymer. In some examples, the first substack may be a first half of the stator, as described above in reference to FIG. 1A. In other examples, several substacks may be used. In some examples, prior to overmolding the first side, a first ring of stamped metal such as stamped ring 702 of FIG. 7 may be attached to the first side (e.g., glued) at an outer circumference of the first side of the first substack, and the first side may be overmolded up to an edge of the first stamped ring. In this way, the edge of the first stamped ring may be a limit of the overmolded material.

At 1804, method 1800 includes overmolding a second side of a second substack of the stator with the polymer. As with the first side, in some examples, a second ring of stamped metal may be attached at an outer circumference of the second side of the second substack, and the second side may be overmolded up to an edge of the second stamped ring.

Additionally, during the overmolding of the first and second sides of the first and second substacks, respectively, an inner circumferential surface of both substacks (e.g., around air gap 160) may also be overmolded. The overmolded material may be extended around outer edges of both substacks, and may form end rings at edges of winding slots of the stator at the outer edges, as described above in reference to FIGS. 15 and 16.

At 1816, method 1800 optionally includes attaching an inner seal and an outer seal (e.g., inner seal 510 and outer seal 508, respectively) to either of the overmolded first side or the overmolded second side. In other embodiments, inner and outer seals may be formed out of the overmolded material (e.g., a lip).

At 1818, method 1800 optionally includes attaching a plurality of compressible elastomer inserts around edges of the winding slots of the stator, on either of the overmolded first side or the overmolded second side, which may serve as mechanical retention for windings of the stator, as described in reference to FIGS. 9, 10, and 11.

At 1810, method 1800 includes coaxially aligning the first substack with the second substack around a central axis (e.g., central axis 181 of FIG. 1C).

At 1812, method 1800 includes aligning a first bolt hole at a first perimeter of the first substack with a second bolt hole at a second perimeter of the second substack. In various examples, a compression limiting eyelet (e.g., compression limiting eyelet 302) may be placed at a junction between the first bolt hole and the second bolt hole, as described in reference to FIG. 3.

At 1814, method 1800 includes inserting a dowel into both of the first bolt hole and the second bolt hole.

At 1816, method 1800 includes rotating the first substack with respect to the second substack, until one or more additional bolt holes arranged around the first perimeter of the first substack are aligned with one or more respective bolt holes arranged around the second perimeter of the second substack.

At 1818, method 1800 includes inserting wires for the windings into the winding slots of the stator, and bending/twisting the windings at outer ends of the stator.

At 1820, method 1800 includes clamping the first substack to the second substack using a first bolt inserted into the first bolt hole and the second bolt hole, and a plurality of additional bolts inserted into the one or more additional bolt holes and the one or more respective bolt holes. Method 1800 ends.

Thus, an overmolded polymer cooling manifold is disclosed herein that may direct a coolant to a hottest part of a stator of an electric machine more efficiently than other cooling systems, and may be assembled more efficiently than the other cooling systems. The manifold may be formed by overmolding facing sides of a plurality of substacks of the stator, such as overmolding a first side of a first half of the stator and a second side of a second half of the stator, where the first side and the second side face each other at an axial center of the stator. The first half and the second half (or various substacks) may be clamped together using bolts and/or locked together using various interlocking axial features formed in each side of the manifold. An interference fit of the various interlocking axial features, as well as compressible elastomer inserts positioned around winding slots, may advantageously provide mechanical retention of windings of the stator. The overmold material used to form the manifold may additionally extend along an inner circumference of an air gap within the stator and around outer edges of the stator, where the overmold material may form curved end rings that protect end windings during bending and twisting operations.

As a result of in-slot cooling with the overmolded manifold, or with a plurality of the manifolds, may eliminate a reliance on slot liners and varnish for limiting relative motion of windings of the stator and providing electrical isolation, while also cooling the hottest part of the electric machine, may positively affect the machine's thermal capabilities. Additionally, by routing the coolant circumferentially and radially around the stator core slots including the windings via the overmolded manifold, heat may be more efficiently and uniformly extracted from the stator than alternative cooling solutions that rely on spraying coolant on surfaces of the stator, which may not direct the coolant at the hottest, central portions of the stator.

The technical effect of cooling the electric machine by routing coolant to one or more of the proposed overmolded cooling manifolds is that the coolant may be directed at the hottest part of the electric machine via passages that are created via a simple and efficient overmolding and assembly process that is less complex and time-consuming than alternative cooling systems.

The disclosure also provides support for a cooling system for an electric machine having a stator, the cooling system comprising: an overmolded polymer cooling manifold positioned at an axial center of the stator and aligned coaxially with a central axis of the stator, the overmolded polymer cooling manifold formed between a first overmolded side of a first half of the stator and a second overmolded side of a second half of the stator, wherein the overmolded polymer cooling manifold is configured to direct a coolant around windings of the stator. In a first example of the system, the stator includes a plurality of overmolded polymer cooling manifolds positioned between a plurality of substacks of the stator. In a second example of the system, optionally including the first example, the overmolded polymer cooling manifold is formed between the first overmolded side of the first half of the stator and the second overmolded side of the second half of the stator as a result of clamping the first half of the stator to the second half of the stator via a plurality of bolts. In a third example of the system, optionally including one or both of the first and second examples, the overmolded polymer cooling manifold includes a plurality of compression limiting eyelets through which the bolts pass. In a fourth example of the system, optionally including one or more or each of the first through third examples, the first overmolded side of the first half of the stator interlocks with the second overmolded side of the second half of the stator via an interference fit between a plurality of interlocking axial features of the overmolded polymer cooling manifold. In a fifth example of the system, optionally including one or more or each of the first through fourth examples, the plurality of interlocking axial features includes protruding portions and recessed portions of each of the first overmolded side of the first half of the stator and the second overmolded side of the second half of the stator, that are configured such that the protruding portions of the first overmolded side insert into the recessed portions of the second overmolded side, and the protruding portions of the second overmolded side insert into the recessed portions of the first overmolded side, and the interference fit is formed by a plurality of interference fits of each protruding portion with a corresponding recessed portion. In a sixth example of the system, optionally including one or more or each of the first through fifth examples, the protruding portions are formed of solid overmold material. In a seventh example of the system, optionally including one or more or each of the first through sixth examples, the protruding portions of a respective overmolded side of the overmolded polymer cooling manifold are positioned adjacent to the recessed portions of the respective overmolded side. In an eighth example of the system, optionally including one or more or each of the first through seventh examples, winding slots of the stator are positioned between pairs of protruding and recessed portions, and the interference fit is additionally formed between windings of the stator and the overmolded polymer cooling manifold, the interference fit providing mechanical retention for the windings. In a ninth example of the system, optionally including one or more or each of the first through eighth examples, the overmolded polymer cooling manifold further comprises compressible elastomer inserts positioned between the first overmolded side and the second overmolded side around each winding slot that provide a mechanical fixation of the windings. In a tenth example of the system, optionally including one or more or each of the first through ninth examples, the overmolded polymer cooling manifold further comprises an outer seal positioned at an outer circumference of the overmolded polymer cooling manifold and an inner seal positioned at an inner circumference of the overmolded polymer cooling manifold that prevents the coolant from leaking out of the overmolded polymer cooling manifold, wherein the compressible elastomer inserts are integrated into the inner seal.

The disclosure also provides support for a cooling manifold of an electric machine, the cooling manifold comprising: a first surface formed by overmolding a first side of a first portion of a stator of the electric machine, a second surface formed by overmolding a second side of a second portion of the stator, wherein the cooling manifold is formed between the first surface and the second surface as a result of one of: clamping the first portion of the stator to the second portion of the stator via a plurality of bolts, and an interference fit between a first plurality of interlocking axial features formed in the first surface and the second surface. In a first example of the system, the first plurality of interlocking axial features is interspaced between a plurality of winding slots of the stator, the first plurality of interlocking axial features including a first protruding portion of the first surface that forms an interference fit with a first recessed portion of the second surface, and a second protruding portion of the second surface that forms an interference fit with a second recessed portion of the first surface. In a second example of the system, optionally including the first example, the system further comprises: an outer seal between the first surface and the second surface positioned at an outer circumference of the cooling manifold, and an inner seal between the first surface and the second surface positioned at an inner circumference of the cooling manifold, that prevent a coolant from leaking out of the cooling manifold. In a third example of the system, optionally including one or both of the first and second examples, the system further comprises: a second set of interlocking axial features arranged around winding slots of the stator that provide mechanical retention for windings within the winding slots. In a fourth example of the system, optionally including one or more or each of the first through third examples, the mechanical retention is additionally achieved by a plurality of compressible elastomer inserts positioned on the cooling manifold around edges of the winding slots. In a fifth example of the system, optionally including one or more or each of the first through fourth examples, the mechanical retention is achieved by rotating the first portion of the stator with respect to the second portion of the stator. In a sixth example of the system, optionally including one or more or each of the first through fifth examples, a boundary of the cooling manifold is formed by an outer ring of stamped metal extending around an outer circumference of the stator that acts as a limit for overmolded material of the cooling manifold.

The disclosure also provides support for a method for assembling an electric machine, the method comprising: overmolding first side of a first substack of a stator of the electric machine with a polymer, overmolding a first side of a second substack of the stator with the polymer, coaxially aligning the first substack with the second substack around a central axis, aligning a first bolt hole at a first perimeter of the first substack with a second bolt hole at a second perimeter of the second substack, inserting a dowel into both of the first bolt hole and the second bolt hole, rotating the first substack with respect to the second substack until a third bolt hole at the first perimeter of the first substack is aligned with a fourth bolt hole at the second perimeter of the second substack, and clamping the first substack to the second substack using at least a first bolt inserted into the first bolt hole and the second bolt hole, and a second bolt inserted into the third bolt hole and the fourth bolt hole. In a first example of the method, the method further comprises: prior to overmolding the first side of the first substack and the first side of the second substack, glueing a first ring of stamped metal around an outer circumference of the first side of the first substack, and glueing a second ring of stamped metal around an outer circumference of the first side of the second substack, overmolding the first side of the first substack with a polymer, up to a first edge of the first stamped metal ring, and overmolding the first side of the second substack with the polymer up to a second edge of the second stamped metal ring.

As explained herein, the overmolded polymer cooling manifold at the center of the stator is made by overmolding two halves of the stator core and creating part of the manifold on each half of the stator core. The center manifold distributes the coolant circumferentially to each of the stator slots. The coolant then flows axially down the slots to cool the stack windings. At the end of the stator core, the coolant may exit the stator and flow onto end windings of the stator, providing additional end winding cooling. Rotor spray cooling may be used to provide additional end winding cooling. An air gap inside the stator may be sealed by including overmolded material on the stator inner diameter.

The coolant may be introduced into the overmolded polymer cooling manifold from the housing via passages in the housing, for example, via a radial seal to the housing or via a bolt feed through a hollow bolt. Mechanical retention may also be used within the slots between the stator windings and the overmolded stator core to prevent relative motion that can lead to insulation degradation. Slot liners and varnish typically used to limit relative motion and provide electrical isolation may be replaced by overmolded polymer with mechanical retention features. As a result, in-slot cooling with the overmolded polymer cooling manifold may eliminate the use of slot liners and varnish, while still reducing relative motion and cooling the hottest spot of the machine, reducing manufacturing cost and complexity while increasing the machine's thermally limited capability

FIGS. 1A-16 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

It will be appreciated that the configurations and routines disclosed herein are exemplary in nature, and that these specific examples are not to be considered in a limiting sense, because numerous variations are possible. The above technology may be applied to other electrified vehicle and systems. For example, the technology may be applied to vehicles or systems using hydrogen fuel cells or another energy source as a source of electricity, or stationary systems with modes of operation for generating rotational energy as a motor and/or electrical energy as a generator. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A cooling system for an electric machine having a stator, the cooling system comprising:
an overmolded polymer cooling manifold positioned at an axial center of the stator and aligned coaxially with a central axis of the stator, the overmolded polymer cooling manifold formed between a first overmolded side of a first half of the stator and a second overmolded side of a second half of the stator;
wherein the overmolded polymer cooling manifold is configured to direct a coolant around windings of the stator.

2. The cooling system of claim 1, wherein the stator includes a plurality of overmolded polymer cooling manifolds positioned between a plurality of substacks of the stator.

3. The cooling system of claim 1, wherein the overmolded polymer cooling manifold is formed between the first overmolded side of the first half of the stator and the second overmolded side of the second half of the stator as a result of clamping the first half of the stator to the second half of the stator via a plurality of bolts.

4. The cooling system of claim 3, wherein the overmolded polymer cooling manifold includes a plurality of compression limiting eyelets through which the bolts pass.

5. The cooling system of claim 1, wherein the first overmolded side of the first half of the stator interlocks with the second overmolded side of the second half of the stator via an interference fit between a plurality of interlocking axial features of the overmolded polymer cooling manifold.

6. The cooling system of claim 5, wherein the plurality of interlocking axial features includes protruding portions and recessed portions of each of the first overmolded side of the first half of the stator and the second overmolded side of the second half of the stator, that are configured such that the protruding portions of the first overmolded side insert into the recessed portions of the second overmolded side, and the protruding portions of the second overmolded side insert into the recessed portions of the first overmolded side, and the interference fit is formed by a plurality of interference fits of each protruding portion with a corresponding recessed portion.

7. The cooling system of claim 6, wherein the protruding portions are formed of solid overmold material.

8. The cooling system of claim 6, wherein the protruding portions of a respective overmolded side of the overmolded polymer cooling manifold are positioned adjacent to the recessed portions of the respective overmolded side.

9. The cooling system of claim 8, wherein winding slots of the stator are positioned between pairs of protruding and recessed portions, and the interference fit is additionally formed between windings of the stator and the overmolded polymer cooling manifold, the interference fit providing mechanical retention for the windings.

10. The cooling system of claim 9, wherein the overmolded polymer cooling manifold further comprises compressible elastomer inserts positioned between the first overmolded side and the second overmolded side around each winding slot that provide a mechanical fixation of the windings.

11. The cooling system of claim 10, wherein the overmolded polymer cooling manifold further comprises an outer seal positioned at an outer circumference of the overmolded polymer cooling manifold and an inner seal positioned at an inner circumference of the overmolded polymer cooling manifold that prevents the coolant from leaking out of the overmolded polymer cooling manifold, wherein the compressible elastomer inserts are integrated into the inner seal.

12. A cooling manifold of an electric machine, the cooling manifold comprising:
a first surface formed by overmolding a first side of a first portion of a stator of the electric machine; and
a second surface formed by overmolding a second side of a second portion of the stator;
wherein the cooling manifold is formed between the first surface and the second surface as a result of one of:
clamping the first portion of the stator to the second portion of the stator via a plurality of bolts; and
an interference fit between a first plurality of interlocking axial features formed in the first surface and the second surface.

13. The cooling manifold of claim 12, wherein the first plurality of interlocking axial features is interspaced between a plurality of winding slots of the stator, the first plurality of interlocking axial features including a first protruding portion of the first surface that forms an interference fit with a first recessed portion of the second surface, and a second protruding portion of the second surface that forms an interference fit with a second recessed portion of the first surface.

14. The cooling manifold of claim 12, further comprising an outer seal between the first surface and the second surface positioned at an outer circumference of the cooling manifold, and an inner seal between the first surface and the second surface positioned at an inner circumference of the cooling manifold, that prevent a coolant from leaking out of the cooling manifold.

15. The cooling manifold of claim 12, further comprising a second set of interlocking axial features arranged around winding slots of the stator that provide mechanical retention for windings within the winding slots.

16. The cooling manifold of claim 15, wherein the mechanical retention is additionally achieved by a plurality of compressible elastomer inserts positioned on the cooling manifold around edges of the winding slots.

17. The cooling manifold of claim 15, wherein the mechanical retention is achieved by rotating the first portion of the stator with respect to the second portion of the stator.

18. The cooling manifold of claim 12, wherein a boundary of the cooling manifold is formed by an outer ring of stamped metal extending around an outer circumference of the stator that acts as a limit for overmolded material of the cooling manifold.

19. A method for assembling an electric machine, the method comprising:
overmolding a first side of a first substack of a stator of the electric machine with a polymer;
overmolding a first side of a second substack of the stator with the polymer;
coaxially aligning the first substack with the second substack around a central axis;
aligning a first bolt hole at a first perimeter of the first substack with a second bolt hole at a second perimeter of the second substack;
inserting a dowel into both of the first bolt hole and the second bolt hole;
rotating the first substack with respect to the second substack until a third bolt hole at the first perimeter of the first substack is aligned with a fourth bolt hole at the second perimeter of the second substack; and
clamping the first substack to the second substack using at least a first bolt inserted into the first bolt hole and the second bolt hole, and a second bolt inserted into the third bolt hole and the fourth bolt hole.

20. The method of claim 19, further comprising:
prior to overmolding the first side of the first substack and the first side of the second substack, glueing a first ring of stamped metal around an outer circumference of the first side of the first substack, and glueing a second ring of stamped metal around an outer circumference of the first side of the second substack;
overmolding the first side of the first substack with a polymer, up to a first edge of the first stamped metal ring; and
overmolding the first side of the second substack with the polymer up to a second edge of the second stamped metal ring.
